(19) United States
(12) Patent Application Publication
(10) Pub. No.: US 2013/0187594 A1
(43) Pub. Date: Jul. 25, 2013

(54) HEARING AID HAVING A BATTERY CHARGER

(71) Applicants: Joachim Roland Barth, Nuernberg (DE); Stefanie Beyfuss, Erlangen (DE); Joseph Sauer, Strullendorf (DE)

(72) Inventors: Joachim Roland Barth, Nuernberg (DE); Stefanie Beyfuss, Erlangen (DE); Joseph Sauer, Strullendorf (DE)

(73) Assignee: SIEMENS MEDICAL INSTRUMENTS PTE. LTD., SINGAPORE (SG)

(21) Appl. No.: 13/824,580

(22) PCT Filed: Aug. 17, 2011
(86) PCT No.: PCT/EP2011/064181

§ 371 Date: Mar. 18, 2013

(30) Foreign Application Priority Data
Sep. 16, 2010 (DE) DE102010040930.8

(51) Int. Cl. H02J 7/00

(52) U.S. Cl. CPC H02J 7/00
USPC 320/107

(57) ABSTRACT

A hearing aid has a battery charger. The hearing aid contains a battery charger having an opening for accommodating a programming module having first programming contacts. Furthermore, second programming contacts are arranged in the hearing aid. The hearing aid is characterized by a sealant inserted in the opening, wherein the sealant covers the second programming contacts when the battery charger is shut off. Thus, the corrosion susceptibility of the second programming contacts is mostly avoided in an advantageous way.

The present invention relates to a hearing device having a battery charger with an opening for accommodating a programming module having first programming contacts, and having second programming contacts.

Hearing devices are portable hearing apparatuses that provide support for people who are hard of hearing. In order to accommodate the numerous individual needs, various design formats of hearing devices are available, such as behind-the-ear (BTE) hearing devices, hearing devices with an external earphone (RIC: receiver in the canal) and in-the-ear hearing devices (ITE), e.g. including concha hearing aids or canal hearing devices (ITE, CIC). The hearing devices cited by way of example are worn on the outer ear or in the auditory canal. Bone conduction hearing aids, implantable or vibrotactile hearing aids are also available. The stimulation of the damaged hearing is either mechanical or electrical in this case.

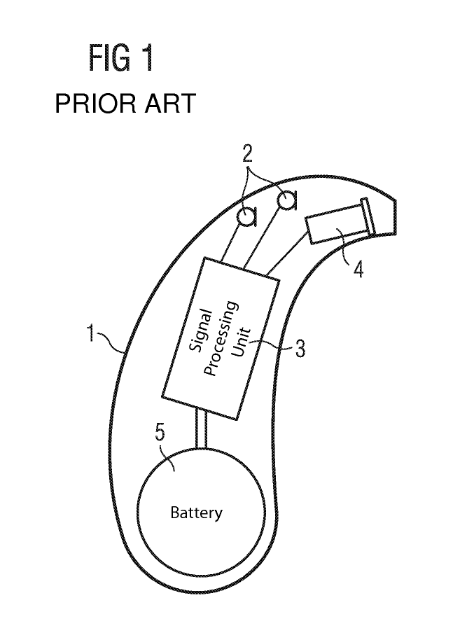

Hearing devices generally comprise an input converter, an amplifier and an output converter as main components. The input converter is usually a sound receiver, e.g. a microphone, and/or an electromagnetic receiver, e.g. an induction coil. The output converter is normally embodied as an electroacoustic converter, e.g. miniature loudspeaker, or as an electromagnetic converter, e.g. bone conduction headphone. The amplifier is usually integrated in a signal processing unit. This basic structure is illustrated in FIG. 1 with reference to the example of a behind-the-ear hearing device. One or more microphones 2 for receiving the sound from the environment are incorporated in a hearing device housing 1 that is worn behind the ear. A signal processing unit 3, which is likewise integrated in the hearing device housing 1, processes and amplifies the microphone signals. The output signal of the signal processing unit 3 is transferred to a loudspeaker or earphone 4, which outputs an acoustic signal. The sound is optionally transferred to the eardrum of the device wearer via a sound tube that is fixed in the auditory canal by means of a molded earpiece. The energy supply of the hearing device and in particular that of the signal processing unit 3 is provided by means of a battery 5 that is likewise integrated in the hearing device housing 1.

Hearing devices are as a rule optionally equipped with non-rechargeable or rechargeable batteries for energy supply purposes. Non-rechargeable batteries are regularly replaced by recharged batteries. Rechargeable batteries must either be removed from the battery holding apparatus and connected to a charging station or they can remain in the battery holding apparatus and be inductively or galvanically charged by way of coils or contacts. The batteries are connected to the signal processor by way of battery contacts, which are generally made of metal. DE 19749 110 A1 discloses a hearing aid device having functional parts arranged in a housing. The functional parts include inter alia a microphone, an earphone, a battery compartment with battery spring contacts and a hearing device socket with electrical connector pins. The battery spring contacts are not accessible from outside of the hearing aid.

Furthermore, hearing devices often comprise sockets with as a rule likewise metal programming contacts, by way of which data can be transmitted from external programming units, like for instance a computer, in order to program and set parameters of the hearing device. The publication EP 0 591 791 B1 describes a programmable hearing aid device, in which the programming contacts can be covered by a flap.

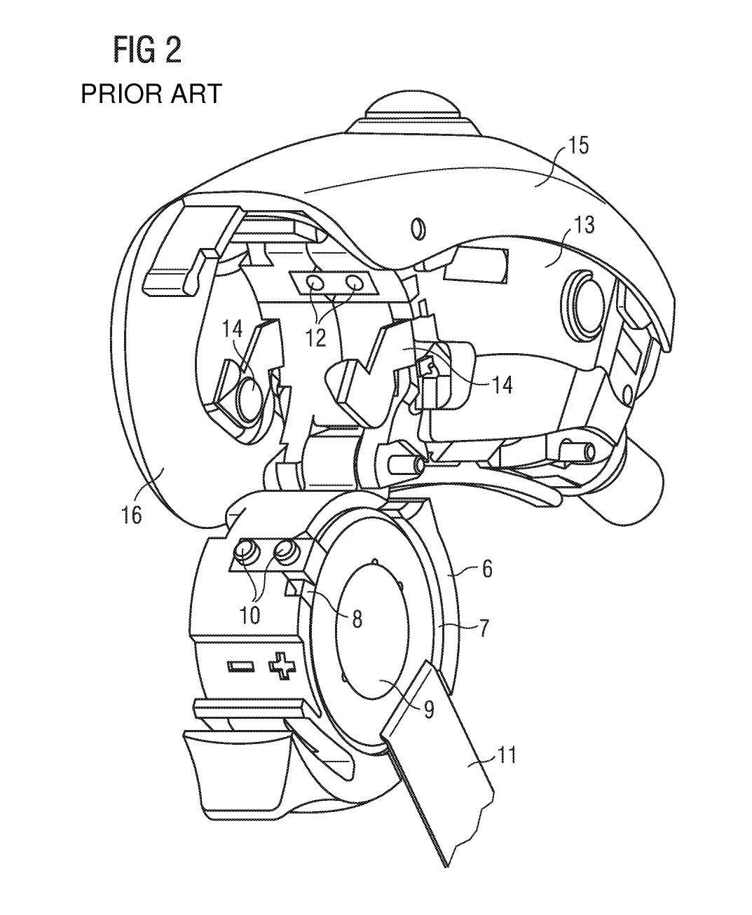

In more recent hearing device models, space optimization of the hearing device components takes place to that effect that a battery charger is used, which, in the normal operating mode, can accommodate a battery for energy supply to the hearing device. In the event of a required programming of the hearing device by a hearing device acoustician for instance, the battery is removed from the battery charger and a programming module is inserted. FIG. 2 shows a known hearing device with a hinged battery charger 6, into which a recess 7 can be incorporated. During normal operation of the hearing device, a battery (not shown) for energy supply to the hearing device is inserted into the recess 7. In the representation shown, the battery was removed from the recess 7 and a programming module 9 was inserted for the purpose of programming the hearing device. The programming module 9 comprises two first programming contacts 10, which leave the battery charger 6 through an opening 8. The programming module 6 includes a conductive tape 11, by way of which the hearing device is energized during the programming process and by way of which the programming signals are transmitted.

With a hinged battery charger 6, the first programming contacts 10 contact two second programming contacts 12, which are incorporated in a hearing device frame 13. The hearing device frame 13 further includes battery contacts 14, which, when the battery charger 6 is hinged, contact the battery and/or the programming module 9. A cover shell 15 and a bottom shell 16, of which only one half is shown, include the hearing device frame 13 when the battery charger 6 is hinged. The programming module 9 is usually inserted into the hearing device by an acoustician in order to program the individually required settings. Once the programming has ended, the programming module 9 is removed again. The end customer does not receive nor need the programming module 6.

Both the second programming contacts and also the battery contacts have the tendency to corrode as a result of sweat and skin particles from the hearing device wearer upon wear of the hearing device. In order to reduce corrosion susceptibility as far as possible, the battery contacts and the second programming contacts are coated numerous times with gold. Contacts of this type are however relatively expensive to manufacture, Furthermore, corrosion cannot be completely prevented by means of the gold coating.

The object of the present invention consists in protecting the second programming contacts from corrosion.

In accordance with the invention, this object is achieved by a hearing device comprising a battery charger with an opening for accommodating a programming module having first programming contacts. Furthermore, second programming contacts are arranged in the hearing device. The link between the programming module and the hearing device is established during the programming of the hearing device by way of the first and second programming contacts. The hearing device is characterized by a sealing means inserted into the opening, which covers the second programming contacts when the battery charger is closed. As a result, the corrosion susceptibility of the second programming contacts is advantageously largely avoided.

In one development of the invention, the second programming contacts can be arranged in a hearing device frame.

In an advantageous embodiment, the sealing means can be permanently detachably arranged in the opening of the battery charger. During normal hearing device operation, the sealing means covers the second programming contacts and protects these from corrosion. In order for the acoustician to program the hearing device, the sealing means is removed and the battery is then removed from the battery charger of the hearing device. This is advantageous in that during normal hearing device operation, the second programming contacts are protected against corrosion.

Furthermore, the surface of the sealing means can be formed in such a way that a tool can be added for insertion in or removal from the opening of the battery charger. The known tools for the insertion and removal of pins into and/or out of the hearing device can therefore advantageously be used in order to remove and reinsert the sealing means. These tools are also known under the term pin removal tool.

The sealing means may advantageously comprise a first, a second and a third part. These parts as components of the sealing means are realized with different functions.

In a further embodiment of the invention, the sealing means can be held in the opening by means of the first part.

Furthermore, the first part can be formed from a hard plastic. As a result, it is possible for the sealing means to be held in the opening by the first part.

In an advantageous design of the invention, the second programming contacts can be covered by the second part. The advantage here is that the second programming contacts are as a result protected against corrosion.

Furthermore, the second part can be formed from a soft plastic. As a result, the required flexibility of the sealing means is advantageously ensured in the part which covers the second programming contacts.

In a development of the invention, the third part may hold a battery inserted into the battery charger.

Furthermore, a spring may be embodied in the third part to hold the battery. This advantageously allows for fixing of a battery inserted into the hearing device.

In an advantageous embodiment, the third part can be formed from a soft plastic. This ensures the required flexibility of the sealing means in the part which holds the battery in the opening.

In an advantageous design, the sealing means can be manufactured using a multicomponent injection molding method. This enables the sealing means to be manufactured with hard and soft parts.

The sealing means can also be embodied such that the sealing means can be engaged in engaging positions and/or catch positions of the hearing device frame or a hearing device housing when the battery charger is open. As a result, the position of the battery charger can advantageously be fixed in respect of the hearing device frame.

In a further embodiment, contact with the battery can be interrupted when the battery charger is opened, by at least one battery contact being raised from the battery. The sealing means can be embodied such that the raising of the battery contact is effected by the grounding onto the sealing means. When the battery charger is closed, the sealing means is pushed out of the engaging position by way of manual pressure and the battery charger is moved into the housing of the hearing device. As a result, contact is established between the battery contacts and the battery, and the hearing device is energized again by way of the battery. When opening and closing, friction occurs between the hearing device frame and/or the hearing device housing and the sealing means fastened in the battery charger and thus wear in particular of the softer frictional partner. The sealing means is expediently designed as the softer frictional partner. The inventive embodiment of the sealing means for catch purposes for fixing the battery charger in respect of the hearing device frame reduces future wear costs and simplifies the service, since, in the event of wear, only the sealing means which has a low manufacturing cost and can be replaced in an easy manner is to be replaced.

In a development of the invention, the color of the sealing means may specify a hearing device left-right identification. A color marker of the sealing means provides information to the wearer of the hearing apparatus, behind which ear the individual hearing device is to be worn. A hitherto required separate marker in the form of labeled panels attached to the battery charger is dispensed with. The risk of two hearing devices to be used being mixed up upon attachment to and/or in the ear is reduced.

Further advantages, features and details of the invention result from the exemplary embodiment described below and with the aid of the schematic drawing, in which;

FIG. 1 shows a basic illustration of a behind-the-ear hearing device according to the prior art,

FIG. 2 shows a perspective view of a behind-the-ear hearing device having a hinged battery charger according to the prior art,

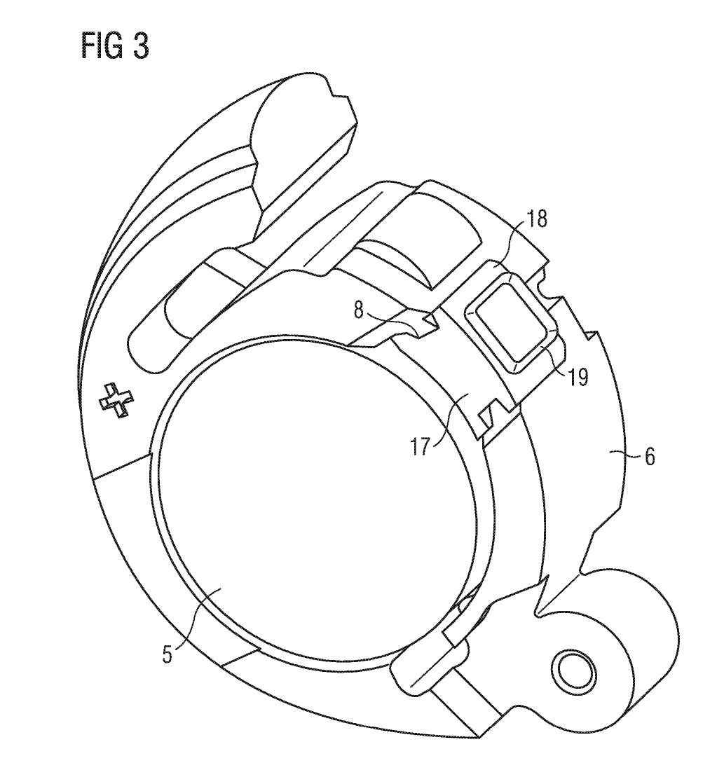

FIG. 3 shows a perspective view of a battery charger having inserted sealing means,

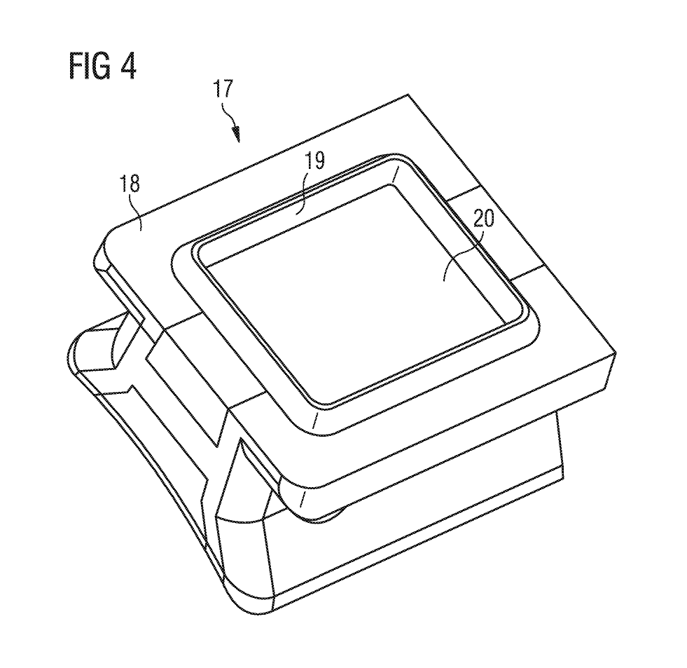

FIG. 4 shows a perspective view of a sealing means,

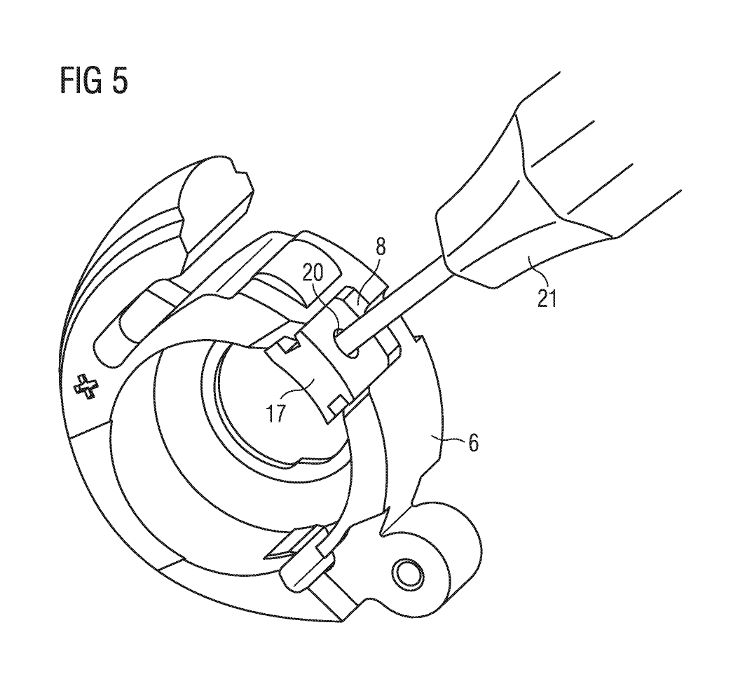

FIG. 5 shows a perspective view of a battery charger having an inserted sealing means and tool,

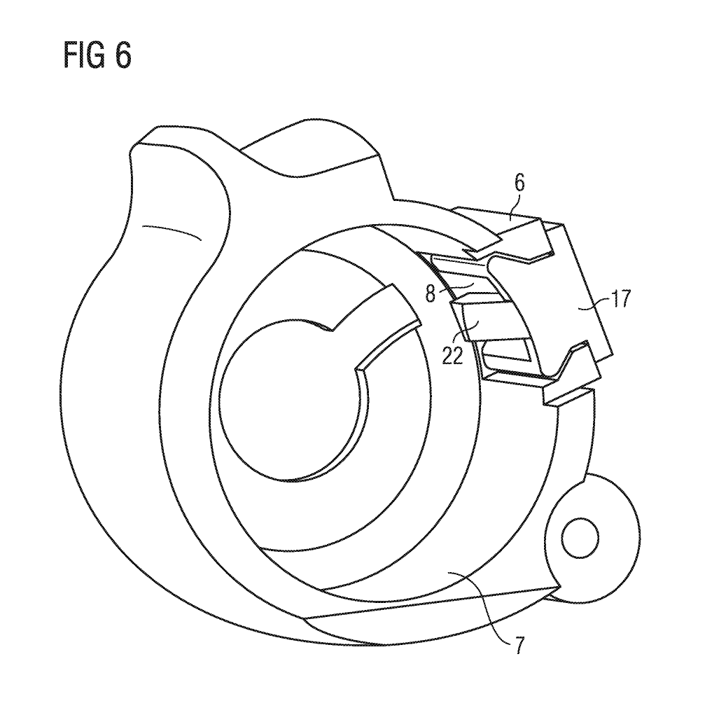

FIG. 6 shows a perspective view of a battery charger having an inserted sealing means, and

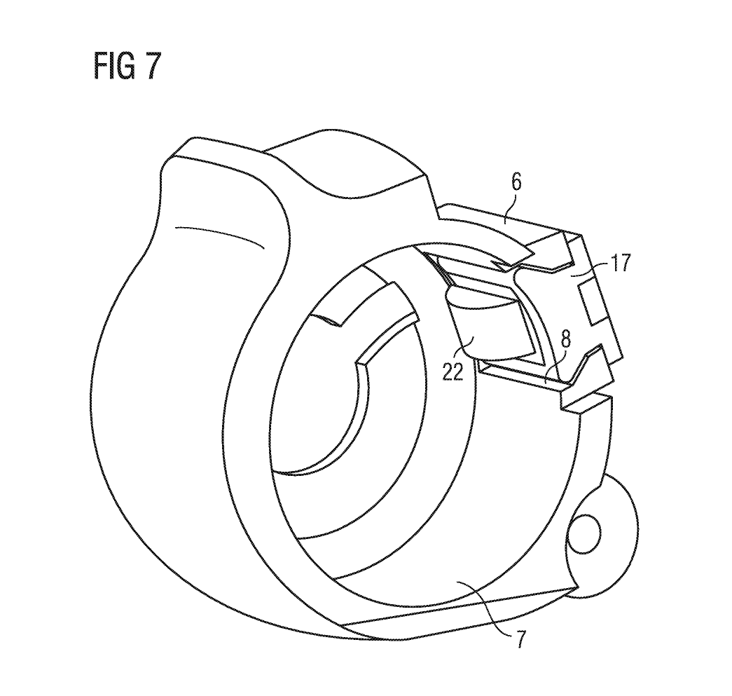

FIG. 7 shows a perspective view of a battery charger having a further embodiment of an inserted sealing means.

FIG. 3 shows a perspective view of a battery charger with an inserted sealing means. A battery charger 6 includes an inserted battery 5, and a sealing means 17, which is inserted into an opening 8 of the battery charger 6. The sealing means 17 comprises a first part 18, which is formed from a hard plastic. The sealing means 17 is held in the battery charger 6 by way of the first part 18. Furthermore, the sealing means 17 comprises a second part 19, which is formed from a soft plastic. The sealing of second programming contacts (not shown) by way of the second part, takes place in order to protect these against corrosion.

FIG. 4 shows a sealing means in detail. The sealing means 17 includes a first part 18 consisting of hard plastic and a second part 19 consisting of soft plastic. The second part 19 comprises an indentation 20. This is used to accommodate second programming contacts (not shown) after folding a battery charger (not shown), into which the sealing means 17 is introduced. The risk of the second programming contacts corroding is largely reduced by completely surrounding the second programming contacts by the indentation 20.

FIG. 5 shows a perspective view of a battery charger with an inserted sealing means and a tool. In a battery charger 6, a sealing means 17, which comprises an indentation 20, is inserted into an opening 8. A known tool 21 can be inserted into the indentation 20, in order to remove the sealing means 17 from the opening 8, or in order to insert the same into the opening 8.

FIG. 6 shows a perspective view of a battery charger having an inserted sealing means. A sealing means 17 is inserted into a battery charger 6 in an opening 8, which includes a third part 22 in the form of a spring. A battery (not shown), which is inserted into a recess 7 of the battery charger 6, can be held by way of the third part 22. The insertion of the battery into the recess 7 may optionally take place by manually pushing the battery by way of the third part 22 of the sealing means 17 already inserted into the opening 8. Alternatively, the battery can be placed in the recess 7 and the sealing means can then be moved into the opening 8 of the battery charger 20 with the aid of a tool (not shown). The third part 22 designed as a spring fixes the battery in the recess 7.

FIG. 7 shows a perspective view of a battery charger having a further embodiment of an inserted sealing means. A sealing means 17 is inserted into a battery charger 6 in an opening 8, which includes a semi-cylindrical third part 22 made of elastic plastic. Insertion of a battery (not shown) into the recess 7 of the battery charger 6 may optionally take place by manually pushing the battery by way of the deformable third part 22 of a sealing means 17 already inserted into the opening 8. Alternatively, the battery (not shown) can be placed in the recess 7 and then the sealing means 17 can be moved into the opening 8 of the battery charger 6 with the aid of a tool (not shown). In the inserted state, the battery is fixed by the third part 22.

### LIST OF REFERENCE CHARACTERS

1 hearing device housing
2 microphone
3 signal processing unit
4 loudspeaker or earphone
5 battery
6 battery charger
7 recess
8 opening
9 programming module
10 first programming contacts
11 conductive tape
12 second programming contacts
13 hearing device frame
14 battery contacts
15 cover shell
16 bottom shell
17 sealing means
18 first part of a sealing means
19 second part of a sealing means
20 indentation
21 tool
22 third part of a sealing means

1-16. (canceled)

17. A hearing device, comprising:
a battery charger having an opening formed therein for accommodating a programming module with first programming contacts;
second programming contacts; and
sealing means inserted into said opening and covering said second programming contacts when said battery charger is closed.

18. The hearing device according to claim 17, further comprising a hearing device frame, said second programming contacts disposed in said hearing device frame.

19. The hearing device according to claim 17, wherein said sealing means is permanently detachably disposed in said opening.

20. The hearing device according to claim 17, wherein said sealing means has a surface molded such that a tool can be added for insertion into or removal from said opening of said battery charger.

21. The hearing device according to claim 17, wherein said sealing means comprises a first part, a second part and a third part.

22. The hearing device according to claim 21, wherein said sealing means is held in said opening by said first part.

23. The hearing device according to claim 21, wherein said first part is formed from a hard plastic.

24. The hearing device according to claim 21, wherein said second programming contacts are covered by said second part.

25. The hearing device according to claim 21, wherein said second part is formed from a soft plastic.

26. The hearing device according to claim 21, wherein said third part holds a battery inserted in said battery charger.

27. The hearing device according to claim 26, wherein said third part is a spring for holding the battery.

28. The hearing device according to claim 21, wherein said third part is formed from a soft plastic.

29. The hearing device according to claim 17, wherein said sealing means is manufactured with a multi-component injection molding method.

30. The hearing device according to claim 18, wherein said sealing means can engage in engaging positions of said hearing device frame or a hearing device housing when said battery charger is opened.

31. The hearing device according to claim 17, wherein said sealing means interrupts a contact with a battery when said battery charger is opened.

32. The hearing device according to claim 17, wherein a color of said sealing means specifies a hearing device left-right identification.
